(19) United States
(12) Patent Application Publication
(10) Pub. No.: US 2006/0134501 A1
(43) Pub. Date: Jun. 22, 2006

(54) Separator for fuel cell, method for preparing the same, and fuel cell stack comprising the same

(76) Inventors: Jong-Ki Lee, Suwon-si (KR); Ho-Jin Kweon, Suwon-si (KR); Jun-Won Suh, Suwon-si (KR)

Correspondence Address: CHRISTIE, PARKER & HALE, LLP, PO BOX 7068, PASADENA, CA, 91109-7068, US

(21) Appl. No.: 11/286,151

(22) Filed: Nov. 23, 2005

(30) Foreign Application Priority Data
Nov. 25, 2004 (KR) 10-2004-0097379
Nov. 25, 2004 (KR) 10-2004-0097380
Nov. 25, 2004 (KR) 10-2004-0097382

(51) Int. Cl. H01M 8/02; B32B 15/04; B05D 5/12

(52) U.S. Cl. 429/38; 428/627; 428/632; 427/115; 427/126.1; 427/126.3

(57) ABSTRACT

The metal separator for a fuel cell of the present invention includes a metal substrate having reactant flow pathways and an electro-conductive anti-corrosion coating layer. The electro-conductive anti-corrosion coating layer covers the surface of the metal substrate on which the reactant flow pathways are formed. The coating layer may include metal carbides, metal oxides, and metal borides. A metal layer for improving adherence is formed between the surface of the metal substrate on which the reactant flow pathways are formed, and the electro-conductive anti-corrosion coating layer.

### CROSS-REFERENCES TO RELATED APPLICATION

This application claims priority to and the benefit of Korean Patent Application Nos. 10-2004-0097379, 10-2004-0097380, and 10-2004-0097382 filed in the Korean Intellectual Property Office on Nov. 25, 2004, the entire contents of which are incorporated herein by reference.

### FIELD OF THE INVENTION

The present invention relates to a metal separator, a method of preparing the same, and a fuel cell stack comprising the same. More particularly, the present invention relates to a lightweight metal separator having excellent anti-corrosion and electro-conductivity characteristics, a method of preparing the same, and a fuel cell stack comprising the same.

### BACKGROUND OF THE INVENTION

A fuel cell is a power generation system for producing electrical energy through the electrochemical redox reaction of an oxidant and a fuel, such as hydrogen, or a hydrocarbon-based material, such as methanol, ethanol, natural gas, or the like. Such fuel cells are a clean energy source capable of replacing fossil fuel energy. They include a stack composed of a unit cell and produce various ranges of power output. Since it has four to ten times higher energy density than a small lithium battery, fuel cells are highlighted as a small portable power source.

Representative exemplary fuel cells include a polymer electrolyte membrane fuel cell (PEMFC) and a direct oxidation fuel cell (DOFC). The direct oxidation fuel cell includes a direct methanol fuel cell which uses methanol as a fuel.

The polymer electrolyte fuel cell has advantages such as high energy and power output. However, it has problems in the need to carefully handle hydrogen gas and the requirement of accessory facilities such as a fuel reforming processor for reforming methane or methanol, natural gas, and the like in order to produce hydrogen as the fuel gas.

On the contrary, a direct oxidation fuel cell has a lower energy density than that of the polymer electrolyte fuel cell, but it has the advantages of the ease of handling the fuel, being capable of operating at a room temperature due to its low operating temperature, and no need for additional fuel reforming processors.

In the above fuel cell, the stack that generates electricity substantially includes several to many unit cells stacked in multi-layers, and each unit cell is formed with a membrane-electrode assembly (MEA) and a separator (also referred to as a bipolar plate). The membrane-electrode assembly has an anode (also referred to as a fuel electrode or an oxidation electrode) and a cathode (also referred to as an air electrode or a reduction electrode) attached to each other with an electrolyte membrane between them.

A fuel is supplied to the anode and is adsorbed on catalysts and the fuel is oxidized to produce protons and electrons. The electrons are transferred to the cathode via an out-circuit, and the protons are transferred to the cathode through a polymer electrolyte membrane. An oxidant is supplied to the cathode, and the oxidant, protons, and electrons are reacted on a catalyst at the cathode to produce electricity along with water.

The separators not only work as passageways for supplying the fuel required for the reaction to the anode and for supplying oxygen to the cathode, but also as current collectors. Since they can prevent explosions or combustion due to direct contact between the fuel and oxidant, they should have low gas permeability and good electro-conductivity.

Currently, graphite is usually used as the separator material, particularly a composite material which is made by pulverizing graphite through a mechanical grinding process to produce micrometer-sized particles and mixing it with a polymer resin.

In the prior art, large amounts by weight percent of graphite should be used in order to obtain appropriate electro-conductivity, and processes, such as those using agitating and molding, are difficult because of an increase of the weight and viscosity of the separator materials. Strength, durability, and stability of the resultant separator composite material cannot be obtained at an appropriate level.

In order to resolve such problems, research has been devoted to a metal separator which can replace a graphite separator. The metal separator has advantages in that an etching process can be performed, costs can be saved, and excellent strength can be realized. However, a separator made of a metal or an alloy-based material may corrode under carbon monoxide, oxygen, and various acidic atmospheres to form an oxide film resulting in deterioration of the fuel cell performance.

### SUMMARY OF THE INVENTION

An exemplary embodiment of the present invention provides a metal separator for a fuel cell having excellent anti-corrosion and electro-conductivity characteristics.

Another embodiment of the present invention provides a method of preparing the metal separator for a fuel cell.

Yet another embodiment of the present invention provides a stack for a fuel cell which includes the metal separator.

According to an embodiment of the present invention, a metal separator for fuel cell is provided which includes a metal substrate having reactant flow pathways and an electro-conductive anti-corrosion coating layer. The electro-conductive anti-corrosion coating layer covers the surface of the metal substrate on which the reactant flow pathways are formed. The coating layer includes a metal compound selected from the group consisting of metal carbides, metal oxides, metal borides, and combinations thereof. A metal layer for improving adherence is formed between the surface of the metal substrate on which the reactant flow pathways are formed and the electro-conductive anti-corrosion coating layer.

According to another embodiment of the present invention, a method for preparing a metal separator is provided which includes forming a metal layer for improving adherence on a surface of the metal separator on which reactant flow pathways are formed, and forming an electro-conductive coating layer by depositing or slurry coating a material selected from the group consisting of metal carbide, metal oxide, metal boride and combinations thereof on the metal layer for improving adherence.

According to yet another embodiment of the present invention, a method for preparing a metal separator is provided which includes the following processes: mixing an electro-conductive anti-corrosion material and a metal powder in a solvent in which a binder is dissolved to prepare a slurry for making a separator; pouring the slurry into a mold followed by drying to form the separator. The electro-conductive anti-corrosion material is selected from the group consisting of metal carbides, metal oxides, and metal borides.

According to still another embodiment of the present invention, a fuel cell stack is provided which includes a membrane-electrode assembly and metal separators positioned at each side of the membrane-electrode assembly. The membrane-electrode assembly includes a polymer electrolyte membrane and electrodes positioned at each side of the polymer electrolyte membrane.

### BRIEF DESCRIPTION OF THE DRAWINGS

FIG. 1 is a schematic cross-sectional view showing a metal separator for a fuel cell according to an embodiment of the present invention.

FIG. 2 is a schematic cross-sectional view showing a metal separator for a fuel cell according to a another embodiment which includes a metal layer for improving adherence.

FIG. 3 is a schematic cross-sectional view showing a metal separator for a fuel cell according to an additional embodiment of the present invention.

FIG. 4 is an exploded perspective view showing a fuel cell stack according to an embodiment of the present invention.

FIG. 5 is a graph showing voltage characteristics of fuel cells according to Examples 1 and 5 and Comparative Example 1 versus operation time.

FIG. 6 is a graph showing voltage characteristics of fuel cells according to Examples 8 and 11 and Comparative Example 1 versus operation time.

FIG. 7 is a graph showing voltage characteristics of fuel cells according to Examples 15 and 18 and Comparative Example 1 versus operation time.

### DETAILED DESCRIPTION OF THE EMBODIMENTS

An embodiment of the present invention will hereinafter be described in detail with reference to the accompanying drawings.

The present invention includes metal separators according to the embodiments described below.

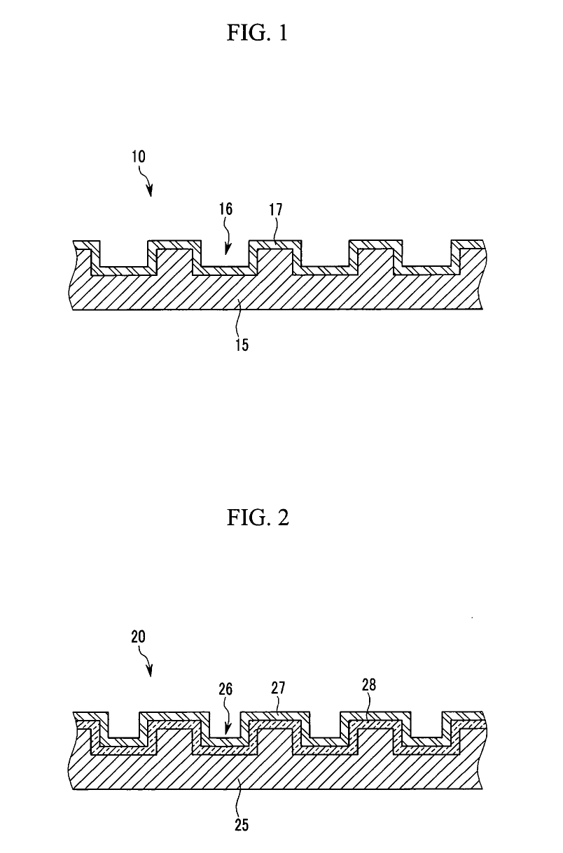

FIG. 1 is a schematic cross-sectional view showing a metal separator for a fuel cell according to an embodiment of the present invention. As shown in FIG. 1, a metal separator 10 according to an embodiment of the present invention includes a metal substrate 15 having reactant flow pathways 16 and an electro-conductive anti-corrosion coating layer 17. The electro-conductive anti-corrosion coating layer 17 covers the surface of the metal substrate 15 on which the reactant flow pathways 16 are formed. The anti-corrosion coating layer 17 may have an average thickness ranging from 0.1 to 100 μm. When the thickness of the coating layer is less than 0.1 μm, the anti-corrosion effect is not sufficient, and when it is more than 100 μm, the extra thickness increase gives no further advantage.

FIG. 2 is a schematic cross-sectional view showing a metal separator for a fuel cell according to another embodiment of the present invention. As shown in FIG. 2, a metal separator 20 according to the embodiment has the same structure as that of the above embodiment except that it includes a metal layer for improving adherence 28 between the electro-conductive anti-corrosion coating layer 27 and the surface of the metal separator 25 on which reactant flow pathways 26 are formed.

The metal layer for improving adherence 28 may have an average thickness ranging from 10 Å to 10000 Å. When the average thickness of the metal layer for improving adherence 28 in less than 10 Å, adherence is not improved suficiently, and when it is more than 10000 Å, adherence does not further increse as the thickness increases.

Metals which may be used in the metal layer for improving adherence 28 may include metals selected from the group consisting of titanium, cobalt, nickel, molybdenum, chromium, an alloy thereof, and combinations thereof. One embodiment of the present invention uses chromium. Since chromium oxide has greater electrical conductivity compared to other metal oxides, there are advantages in that contact force increases and electrical conductivity cannot be deteriorated even though an oxide is formed.

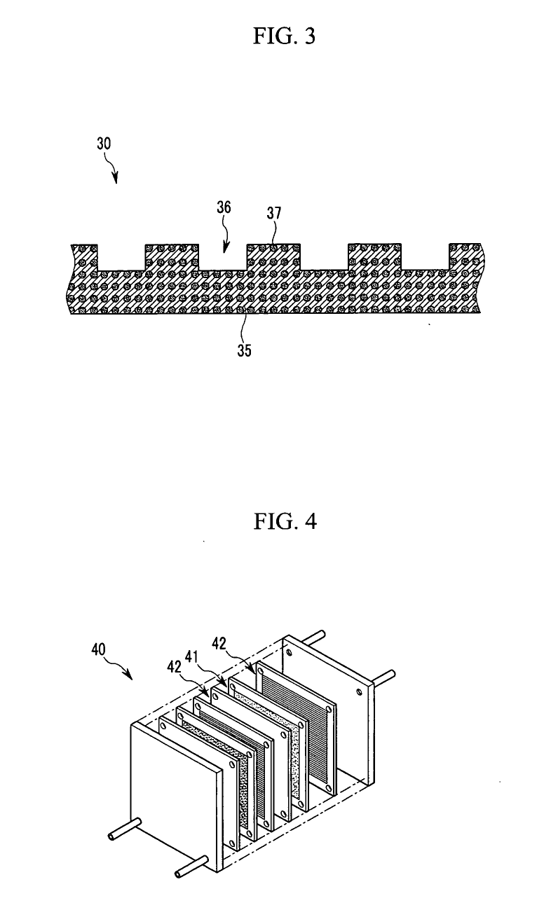

FIG. 3 is a schematic cross-sectional view showing a metal separator according to an additional embodiment of the present invention. As shown in FIG. 3, a metal separator 30 according to the third embodiment includes a mixture of electro-conductive anti-corrosion materials 37 and metals 35, and reactant flow pathways 36 on its surface. The electro-conductive anti-corrosion materials 37 may be selected from the group consisting of metal carbide, metal oxide, metal boride, and mixtures thereof. The reactant flow pathways 36 are formed on the surface of the metal separator 30.

The electro-conductive anti-corrosion materials 37 and the metals 35 may be mixed in weight ratios ranging from 20:80 to 80:20. When the weight ratio of the anti-corrosion materials 37 is less than 20, anti-corrosion decreases, and when it is more than 80, electrical conductivity may be deteriorated.

In the above embodiments, the resultant reactant flow pathways 16, 26, and 36 may be formed in various shapes, as needed. In an embodiment of the present invention, the depth of the reactant flow pathways is less than or equal to 2000 μm, and preferably from 400 to 1000 μm and the width of the reactant flow pathways is less than or equal to 3000 μm, and preferably 500 to 1500 μm. When the depth is more than 2000 μm or the width is more than 3000 μm, it is difficult for a fuel cell including the separator to be down-sized.

The electro-conductive anti-corrosion materials used in the metal separator have excellent anti-corrosion and electric conductivity characteristics.

In an embodiment of the present invention, the electro-conductive anti-corrosion materials may be selected from the group consisting of metal carbides, metal oxides, metal borides, and mixtures thereof. The material in the embodiment has a corrosion value less than or equal to 16 μA/cm2, preferably less than or equal to 10 μA/cm2, and more preferably 0 μA/cm2. The corrosion value represents a current amount which occurs during metal corrosion. When the corrosion value is 0 μA/cm2, a metal is not corroded. When the value is more than 16 μA/cm2, electrical conductivity may be reduced.

In an embodiment of the present invention, the material may have electrical conductivity greater than or equal to 100 S/cm, preferably greater than or equal to 200 S/cm, and more preferably ranging from 200 S/cm to 105 S/cm. When the electro-conductive anti-corrosion material has electrical conductivity of less than 100 S/cm, it cannot perform as a metal separator for a fuel cell.

The metal of the metal carbides, metal oxides, and metal borides may include metals which are generally used for a metal separator for a fuel cell. Non-limiting examples of the metals include those selected from the group consisting of aluminum, titanium, niobium, chromium, tin, molybdenum, zinc, zirconium, vanadium, hafnium, tantalum, tungsten, indium, stainless steel, alloys thereof, and combinations thereof.

In an embodiment of the invention, the metal carbides having the above properties may include those selected from the group consisting of titanium carbide (TiC), zirconium carbide (ZrC), hafnium carbide (HfC), vanadium carbide (VC), niobium carbide (NbC), tantalum carbide (TaC), tungsten carbide (WC), and combinations thereof.

The metal oxides having the above properties may include any metal oxide generally used in a fuel cell. In an embodiment of the present invention It may include one selected from the group consisting of indium tin oxide (ITO), indium zinc oxide (IZO), aluminum zinc oxide (AZO), and combinations thereof.

The metal borides having the above properties may include one selected from the group consisting of titanium boride (TiB2), zirconium boride (ZrB2), and chromium boride (CrB2), and combinations thereof.

The metal substrate may include metals generally used for a metal separator for a fuel cell. Non-limiting examples of the metals include those selected from the group consisting of aluminum, titanium, niobium, chromium, tin, molybdenum, zinc, zirconium, vanadium, hafnium, tantalum, tungsten, indium, stainless steel, alloys thereof, and combinations thereof.

In an embodiment of the present invention, the metal separator may be fabricated by forming an electro-conductive anti-corrosion coating layer on a surface of the metal substrate on which reactant flow pathways are formed using deposition or slurry coating.

In the embodiment, the electro-conductive anti-corrosion coating layer has an average thickness ranging from 0.1 to 100 μm . When the thickness of the electro-conductive anti-corrosion coating layer is less than 0.1 μm, an anti-corrosion effect is not sufficient, and when it is more than 100 μm, there is no further advantage as the thickness increases.

The deposition may include any general deposition method such as sputtering, thermal evaporation, electron beam evaporation, plasma enhanced vapor deposition (PECVD), physical vapor deposition (PVD), or chemical vapor deposition (CVD). These methods may be performed successively.

The slurry coating method may be spin coating, spray coating, or wash coat method. The slurry coating methods use well-known techniques which will therefore not be described in detail herein.

The metal separator according to another second embodiment may be fabricated by forming a metal layer for improving adherence before the vacuum 5 deposition or slurry coating in order to improve adherence between the anti-corrosion coating layer and the metal substrate.

The metal layer for improving adherence 28 is formed using a general vacuum deposition or a slurry coating such as spin coating, spray coating, or wash coat method. In an embodiment of the present invention, the metal layer has an average thickness ranging from 10 Å to 10000 Å. When the thickness is less than 10 Å, adherence is not sufficient and when it is more than 10000 Å, adherence does not further increase.

The metal layer for improving adherence may include a metal such as one selected from the group consisting of titanium, cobalt, nickel, molybdenum, chromium, alloys thereof and combinations thereof. One embodiment of the present invention uses chromium.

The metal separator according to a further embodiment may be fabricated by the following processes: an electro-conductive anti-corrosion material and a metal powder are mixed in an organic solvent, including a binder dissolved therein, to prepare a slurry, and the slurry is poured into a mold and dried to form a separator.

The electro-conductive anti-corrosion material and the metal powder may be mixed in a weight ratio ranging from 20:80 to 80:20. The organic solvent and binder may be those which are generally used for preparing a slurry, and it is particularly not limited.

The electro-conductive anti-corrosion material used in the metal separator of the above embodiments has excellent anti-corrosion and electric conductivity characteristics.

In the above embodiments, the anti-corrosion material has a corrosion value of less than or equal to 16 μA/cm2, preferably less than or equal to 10 μA/cm2, and more preferably 0 μA/cm2. The corrosion value represents a current amount which occurs during metal corrosion. When the corrosion value is 0 μA/cm2, a metal is not corroded. When the value is more than 16 μA/cm2, electrical conductivity may be reduced.

The anti-corrosion materials may have electrical conductivity greater than or equal to 100 S/cm, preferably more than or equal to 200 S/cm, and more preferably ranging from 200 S/cm to 105 S/cm. When the anti-corrosion material has electrical conductivity of less than 100 S/cm, it cannot perform as a metal separator for a fuel cell.

The metal carbides having the above properties may include one selected from the group consisting of titanium carbide (TiC), zirconium carbide (ZrC), hafnium carbide (HfC), vanadium carbide (VC), niobium carbide (NbC), tantalum carbide (TaC), and tungsten carbide (WC), and combinations thereof.

The metal oxides having the above properties may include any metal oxide generally used in a fuel cell. It may include one selected from the group consisting of indium tin oxide (ITO), indium zinc oxide (IZO), aluminum zinc oxide (AZO), and combinations thereof.

The metal borides having the above properties may include at least one selected from the group consisting of titanium boride (TiB2), zirconium boride (ZrB2), and chromium boride (CrB2).

Metal substrates or metal powders according to the above embodiments include metals generally used for a metal separator for a fuel cell. Non-limiting examples of the metals include those selected from the group consisting of aluminum, titanium, niobium, chromium, tin, molybdenum, zinc, zirconium, vanadium, hafnium, tantalum, tungsten, indium, stainless steel, alloys thereof, and combinations thereof.

The metal separator for a fuel cell may be applied to various fuel cells such as a polymer electrolyte fuel cell (PEMFC) or a direct oxidation fuel cell (DOFC).

FIG. 4 is an exploded perspective view showing a fuel cell stack according to one embodiment of the present invention. The stack for a fuel cell of the present invention is not limited to the structure illustrated in FIG. 4.

Referring to FIG. 4, a fuel cell stack 40 includes a membrane-electrode assembly 41 and separators 42 positioned at each side of the membrane-electrode assembly 41 which includes a polymer electrolyte membrane and electrodes positioned at each side of the polymer electrolyte membrane.

The membrane-electrode assembly (MEA) 41 performs oxidation/reduction of hydrogen in a fuel and oxygen in air to generate electricity, and the separators supply the fuel and air to the membrane-electrode assembly.

The membrane-electrode assembly 41 includes an electrolyte membrane, a cathode catalyst layer at one face of the electrolyte membrane, an anode catalyst layer at the other face of the electrolyte membrane, and diffusion layers (DL) positioned on an outer surface of the cathode catalyst layer and the anode catalyst layer. It may also include a microporous layer (MPL) between the cathode catalyst layer or anode catalyst layer, and the diffusion layer, as needed.

The membrane-electrode assembly 41 includes an electrolyte membrane interposed between the anode and cathode catalyst layers.

A fuel is supplied to the anode through a separator. The anode includes a catalyst layer for producing electrons and protons by oxidation of the fuel, and a diffusion layer (DL) for transferring the fuel smoothly.

An oxidant is supplied to the cathode through a separator. The cathode includes a catalyst layer for producing water by reduction of the oxidant, and a diffusion layer for transferring the oxidants smoothly. The electrolyte membrane has a thickness ranging from 50 to 200 μm and plays the ion exchange role of transferring protons produced at the anode catalyst layer to the cathode catalyst layer.

The separator plays the role of a conductor connecting the anode and the cathode of the membrane-electrode assembly in series. The separators work as passageways for supplying the fuel and the oxidant required for the oxidation/reduction reaction to the membrane-electrode assembly. For this purpose, reactant flow pathways for supplying the reactants required for the oxidation/reduction reaction of the membrane-electrode assembly are formed on surfaces of the separators.

The separators are disposed at each side of the membrane-electrode assembly and are closely adjacent to the anode and the cathode of the membrane-electrode assembly.

The following examples illustrate the present invention in more detail. However, it is understood that the present invention is not limited by these examples.

### EXAMPLES

### Example 1

Metal Separator for a Fuel Cell Including a Tungsten Carbide (WC) Coating Layer

A metal separator for a fuel cell including a 30 μm thick tungsten carbide (WC) coating layer was prepared by sputtering tungsten carbide (WC) on the surface of a stainless steel (316L) substrate with reactant flow pathways formed thereon.

A membrane-electrode assembly for a fuel cell was prepared by disposing electrodes including a platinum catalyst at each side of a poly (perfluorosulfonic acid) polymer electrolyte membrane, and then, a fuel cell was fabricated by disposing the metal separators at each side of the membrane-electrode assembly and assembling them.

### Example 2

Metal Separator for a Fuel Cell Including a Titanium Carbide (TiC) Coating Layer

A metal separator for a fuel cell including a 30 μm thick TiC coating layer was prepared by sputtering titanium carbide (TiC) on the surface of a stainless steel (316L) substrate with reactant flow pathways formed thereon.

A fuel cell was fabricated according to the same method as in Example 1 except that the above metal separator was used.

### Example 3

Metal Separator for a Fuel Cell Including a Zirconium Carbide (ZrC) Coating Layer

A separator for a fuel cell including a 30 μm thick ZrC coating layer was prepared by sputtering ZrC on the surface of a stainless steel (316L) substrate with reactant flow pathways formed thereon.

A fuel cell was fabricated according to the same method as in Example 1 except that the above metal separator was used.

### Example 4

Metal Separator for a Fuel Cell Including a Hafnium Carbide (HfC) Coating Layer

A metal separator for a fuel cell including a 30 μm thick HfC coating layer was prepared by sputtering HfC on the surface of a stainless steel (316L) substrate with reactant flow pathways formed thereon.

In addition, a fuel cell was fabricated according to the same method as in Example 1 except that the above metal separator was used.

### Example 5

Metal Separator for a Fuel Cell Including a Metal Layer for Improving Adherence and a Tungsten Carbide (WC) Coating Layer

A metal separator including a metal layer for improving adherence and WC coating layer was prepared by sputtering chromium on the surface of a stainless steel (316L) substrate with reactant flow pathways formed thereon to form a 100 Å thick layer, and then, sputtering WC to form a 30 μm thick coating layer.

A fuel cell was fabricated according to the same method as in Example 1 except that the above metal separator was used.

### Example 6

Metal Separator for a Fuel Cell Including a Tungsten Carbide (WC) Slurry Coating Layer

A slurry for coating was prepared by mixing 3.5 g of polyvinylidenefluoride (PVdF), 481.5 g of N-methylpyrrolidone (NMP), and 50 g of tungsten carbide (WC). The slurry was coated on the surface of a stainless steel substrate (316L) with reactant flow pathways formed thereon, and then, dried to fabricate a metal separator for a fuel cell including a 100 μm thick WC slurry coating layer.

A fuel cell was fabricated according to the same method as in Example 1 except that the above metal separator was used.

### Example 7

Metal Separator for a Fuel Cell Including a Metal Layer for Improving Adherence and a Tungsten Carbide (WC) Slurry Coating Layer

A metal separator for a fuel cell including a metal layer for improving adherence and a 100 μm thick WC slurry coating layer was prepared by sputtering chromium onto the surface of a stainless steel (316L) substrate with reactant flow pathways thereon to form a metal layer for improving adherence. A slurry for coating was prepared by mixing 3.5 g of polyvinylidenefluoride (PVdF), 481.5 g of N-methylpyrrolidone (NMP), and 50 g of tungsten carbide (WC). The slurry was coated on the surface of the stainless steel (316L) substrate with the metal layer for improving adherence, and then dried to fabricate a metal separator on which a 100 Å thick metal layer for improving adherence and a 100 μm thick WC slurry coating layer were formed.

A fuel cell was fabricated according to the same method as in Example 1 except that the above metal separator was used.

### Comparative Example 1

Stainless Steel Separator for a Fuel Cell

A fuel cell was fabricated according to the same method as in Example 1 except that a stainless steel (316L) substrate with reactant flow pathways formed thereon was used as a separator.

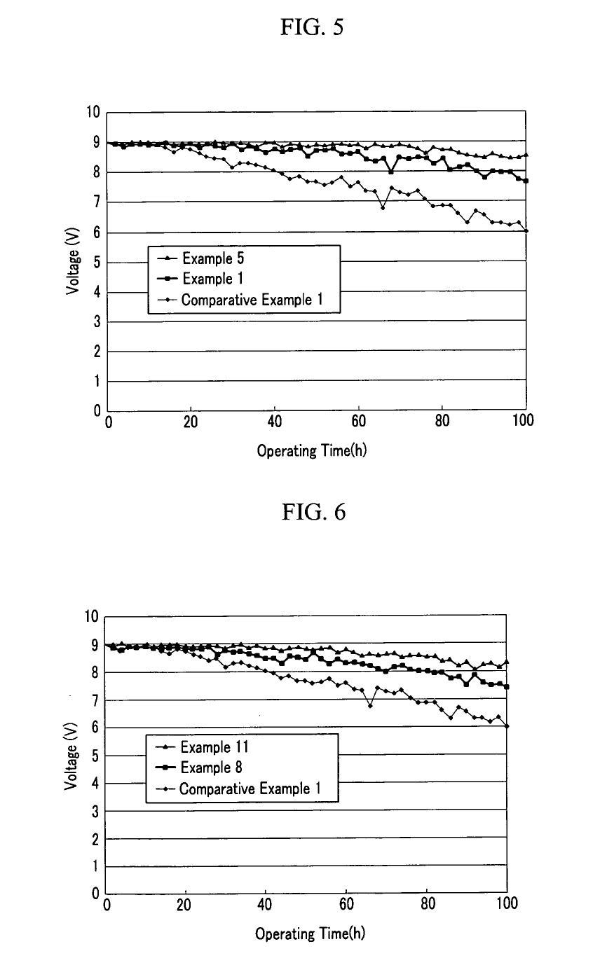

Then, fuel cells fabricated according to Examples 1 and 5, and Comparative Example 1 were evaluated by measuring their voltage characteristics depending on the operating time, and the results are shown in FIG. 5.

### Example 8

Metal Separator for a Fuel Cell Including an ITO Coating Layer

A separator for a fuel cell was prepared by sputtering ITO on the surface of a stainless steel (316L) substrate with reactant flow pathways formed thereon to form a 30 μm thick ITO coating layer.

A fuel cell was fabricated by, first, preparing a membrane-electrode assembly for a fuel cell by deposing electrodes comprising a platinum catalyst at each side of a poly (perfluorosulfonic acid) polymer electrolyte membrane and then, disposing a metal separator for a fuel cell at each side of the membrane-electrode assembly.

### Example 9

Metal Separator for a Fuel Cell Including an IZO Coating Layer

A metal separator for a fuel cell was prepared by sputtering IZO on the surface of a stainless steel (316L) substrate with reactant flow pathways formed thereon to form a 30 μm thick IZO coating layer.

A fuel cell was fabricated according to the same method as in Example 8 except that the above metal separator was used.

### Example 10

Metal Separator for a Fuel Cell Including an AZO Coating Layer

A metal separator for a fuel cell was prepared by sputtering AZO on the surface of a stainless steel (316L) substrate with reactant flow pathways formed thereon to form a 30 μm thick AZO coating layer.

A fuel cell was fabricated in the same method as in Example 8 except that the above metal separator was used.

### Example 11

Metal Separator Including a Metal Layer for Improving Adherence and ITO Coating Layer

Chromium was coated using sputtering on the surface of a stainless steel (316L) substrate with reactant flow pathways formed thereon to form a metal layer for improving adherence, and then ITO was coated using sputtering to form a coating layer to fabricate a metal separator on which a 100 Å thick metal layer for improving adherence and a 30 μm thick ITO coating layer were formed.

A fuel cell was fabricated according to the same method as in Example 8 except that the above metal separator was used.

### Example 12

Metal Separator for a Fuel Cell Including an ITO Slurry Coating Layer

A slurry for coating was prepared by mixing 3.5 g of polyvinylideneflroride (PVdF), 481.5 g of N-methylpyrrolidone (NMP), and 50 g of ITO. The slurry was coated on the surface of a stainless steel substrate (316L) with reactant flow pathways formed thereon, and then dried to fabricate a metal separator for a fuel cell including a 100 μm thick ITO slurry coating layer.

A fuel cell was fabricated according to the same method as in Example 8 except that the above metal separator was used.

### Example 13

Metal Separator for a Fuel Cell Including a Metal Layer for Improving Adherence and ITO Slurry Coating Layer

Chromium was coated using sputtering on the surface of a stainless steel (316L) substrate with reactant flow pathways formed thereon to form a metal layer for improving adherence. A slurry was prepared by mixing 3.5 g of polyvinylidene fluoride (PVdF), 481.5 g of N-methylpyrrolidone (NMP), and 50 g of ITO. The slurry was coated on the metal layer for improving adherence of the stainless steel (316L) substrate, and dried to fabricate a metal separator on which a 100 Å thick metal layer for improving adherence and an ITO slurry coating layer were formed.

A fuel cell was fabricated according to the same method as in Example 8 except that the above separator was used.

### Example 14

Metal Separator for a Fuel Cell Including a Mixture of ITO and a Metal

A slurry for preparing a metal separator for a fuel cell was prepared by mixing 3.5 g of polyvinylidenefluoride (PVdF), 481.5 g of N-methylpyrrolidone (NMP), 50 g of ITO, and 50 g of stainless steel powder. The slurry was poured into a mold with reactant flow pathway shapes and dried to form a metal separator for a fuel cell comprising ITO and stainless steel.

A fuel cell was fabricated according to the same method as in Example 8 except that the above metal separator was used.

Fuel cells fabricated according to Examples 8 and 11, and Comparative Example 1 were evaluated by measuring their voltage characteristics depending on the operating time, and the results are shown in FIG. 6.

### Example 15

Metal Separator for a Fuel Cell Including a Titanium Boride (TiB₂) Coating Layer

A metal separator for a fuel cell including a 30 μm thick TiB₂ coating layer was prepared by sputtering titanium boride (TiB₂) on the surface of a stainless steel (316L) substrate with reactant flow pathways formed thereon.

A fuel cell was fabricated by preparing a membrane-electrode assembly for a fuel cell, where a poly (perfluorosulfonic acid) polymer electrolyte membrane has an electrode including a platinum catalyst at each side, disposing the above metal separator for a fuel cell at each side of the membrane-electrode assembly, and assembling them.

### Example 16

Metal Separator for a Fuel Cell Including a Zirconium Boride (ZrB₂) Coating Layer

A metal separator for a fuel cell including a ZrB₂ coating layer was prepared by sputtering zirconium boride (ZrB₂) on the surface of a stainless steel (316L) substrate with reactant flow pathways formed thereon to form a 30 μm thick layer.

A fuel cell was fabricated according to the same method as in Example 15 except that the above separator was used.

### Example 17

Metal Separator for a Fuel Cell Including a Chromium Boride (CrB₂) Coating Layer

A metal separator for a fuel cell was prepared by sputtering chromium boride (CrB₂) on the surface of a stainless steel (316L) substrate with reactant flow pathways formed thereon to form a 30 μm thick CrB₂ coating layer.

A fuel cell was fabricated according to the same method as in Example 15 except that the above separator was used.

### Example 18

Metal Separator for a Fuel Cell Including a Titanium Boride (TiB₂) Coating Layer and a Metal Layer for Improving Adherence

A metal separator for a fuel cell including a TiB₂ coating layer and a metal layer for improving adherence was prepared by sputtering chromium on the surface of a stainless steel (316L) substrate with reactant flow pathways formed thereon to form a 100 Å thick layer, and then, by sputtering titanium boride (TiB₂) to form a 30 μm thick layer thereon.

A fuel cell was fabricated according to the same method as in Example 15 except that the above metal separator was used.

### Example 19

Metal Separator for a Fuel Cell Including a Titanium Boride (TiB₂) Slurry Coating Layer

A slurry for coating was prepared by mixing 3.5 g of polyvinylidenefluoride (PVdF), 481.5 g of N-methylpyrrolidone (NMP), and 50 g of TiB₂. The slurry was coated on the surface of a stainless steel (316L) substrate with reactant flow pathways formed thereon, and then dried to fabricate a metal separator for a fuel cell including a 100 μm thick TiB₂ slurry coating layer.

A fuel cell was fabricated according to the same method as in Example 15 except that the above separator was used.

### Example 20

Metal Separator for a Fuel Cell Including a Titanium Boride (TiB₂) Slurry Coating Layer and a Metal Layer for Improving Adherence

A metal separator for a fuel cell including a TiB₂ slurry coating layer and a metal layer for improving adherence was prepared by sputtering chromium onto the surface of a stainless steel (316L) substrate with reactant flow pathways formed thereon to form a metal layer for improving adherence. A slurry was prepared by mixing 3.5 g of polyvinylidenefluoride (PVdF), 481.5 g of N-methylpyrrolidone (NMP), and 50 g of TiB₂. The slurry was coated on the metal layer for improving adherence of the stainless steel substrate, and dried to fabricate a 100 Å thick metal separator on which a metal layer for improving adherence and a 100 μm thick TiB₂ slurry coating layer were formed.

A fuel cell was fabricated according to the same method as in Example 15 except that the above separator was used.

### Example 21

Metal Separator for a Fuel Cell Comprising a Mixture of Titanium Boride (TiB₂) and a Metal

A slurry for a metal separator was prepared by mixing 3.5 g of polyvinylidenefluoride (PVdF), 481.5 g of N-methylpyrrolidone (NMP), and 50 g of TiB₂. The slurry was poured into a mold with reactant flow pathway shapes and dried to prepare a metal separator for a fuel cell including a mixture of TiB₂ and stainless steel.

A fuel cell was fabricated according to the same method as in Example 15 except that the above separator was used.

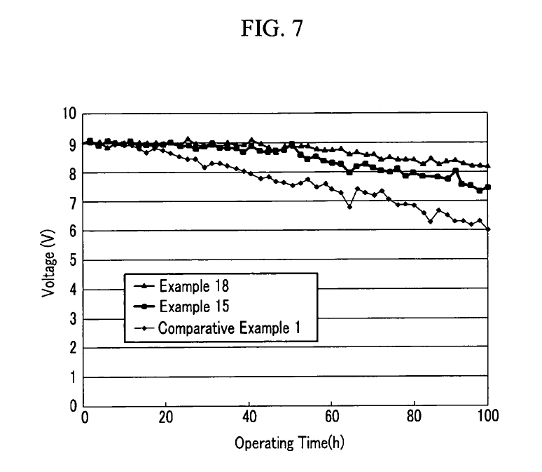

Then, fuel cells fabricated according to Examples 15 and 18, and Comparative Example 1 were evaluated by measuring their voltage characteristics depending on the operating time, and the results are shown in FIG. 7.

As shown in FIGS. 5 to 7, a metal separator for a fuel cell fabricated according to Examples of the present invention turned out to have excellent anti-corrosion and electroconductivity characteristics, effectively maintaining a voltage with the operating time.

A metal separator for a fuel cell of the present invention is not only lightweight but is also fit for a fuel cell due to its excellent anti-corrosion and electroconductivity characteristics. Particularly, a deposition method adopted for preparing the separator enables a metal separator with fine reactant flow pathways to have a coating layer and also, it has advantages of down-sizing a fuel cell, simplifying its manufacturing process, and improving productivity.

While this invention has been described in connection with what are presently considered to be exemplary embodiments, it is to be understood that the invention is not limited to the disclosed embodiments, but, on the contrary, is intended to cover various modifications and equivalent arrangements included within the spirit and scope of the appended claims.

What is claimed is:

1. A separator for a fuel cell comprising:
a metal substrate having a surface forming reactant flow pathways;
a metal layer on the surface of the metal substrate on which the reactant flow pathways are formed; and
an electro-conductive anti-corrosion layer on the metal layer, wherein the electro-conductive anti-corrosion coating layer comprises an anti-corrosion material selected from the group consisting of metal carbides, metal oxides, metal borides, and combinations thereof.

2. The separator of claim 1, wherein the anti-corrosion layer has an average thickness from 0.1 to 100 μm.

3. The separator of claim 1, wherein the metal layer has an average thickness from 10 to 10000 Å.

4. The separator of claim 1, wherein the metal in the metal layer is selected from the group consisting of titanium, cobalt, nickel, molybdenum, chromium, alloys thereof, and combinations thereof.

5. The separator of claim 1, wherein the reactant flow pathways have a depth less than or equal to 2000 μm.

6. The separator of claim 1, wherein the reactant flow pathways have a depth from 400 to 1000 μm.

7. The separator of claim 1, wherein the reactant flow pathways have a width less than or equal to 3000 μm.

8. The separator of claim 1, wherein the reactant flow pathways have a width from 500 to 1500 μm.

9. The separator of claim 1, wherein the anti-corrosion material has electrical conductivity greater than or equal to 100 S/cm.

10. The separator of claim 1, wherein the anti-corrosion material has a corrosion value less than or equal to 16 μA/cm2.

11. The separator of claim 1, wherein the metal carbide is selected from the group consisting of titanium carbide (TiC), zirconium carbide (ZrC), hafnium carbide (HfC), vanadium carbide (VC), niobium carbide (NbC), tantalum carbide (TaC), tungsten carbide (WC), and combinations thereof.

12. The separator of claim 1, wherein the metal oxide is selected from the group consisting of indium tin oxide (ITO), indium zinc oxide (IZO), aluminum zinc oxide (AZO), and combinations thereof.

13. The separator of claim 1, wherein the metal boride is selected from the group consisting of titanium boride (TiB2), zirconium boride (ZrB2), chromium boride (CrB2), and combinations thereof.

14. The separator of claim 1, wherein the metal substrate is selected from the group consisting of aluminum, titanium, niobium, chromium, tin, molybdenum, zinc, zirconium, vanadium, hafnium, tantalum, tungsten, indium, stainless steel, alloys thereof, and combinations thereof.

15. A separator for a fuel cell comprising:
a metal substrate upon which reactant flow pathways are formed and coated with a mixture of a metal and an electro-conductive anti-corrosion material selected from the group consisting of metal carbides, metal oxides, metal borides, and combinations thereof.

16. A method for making a separator for a fuel cell comprising:
forming a metal layer on a metal substrate on which reactant flow pathways are formed; and
coating an electro-conductive anti-corrosion material selected from the group consisting of metal carbides, metal oxides, metal borides, and combinations thereof, onto the metal layer using deposition or slurry coating.

17. The method of claim 16, wherein the metal in the metal layer is formed by coating a metal selected from the group consisting of titanium, cobalt, nickel, molybdenum, chromium, alloys thereof, and combinations thereof.

18. The method of claim 16, wherein the metal carbide is selected from the group consisting of titanium carbide (TiC), zirconium carbide (ZrC), hafnium carbide (HfC), vanadium carbide (VC), niobium carbide (NbC), tantalum carbide (TaC), tungsten carbide (WC), and combinations thereof.

19. The method of claim 16, wherein the metal oxide is selected from the group consisting of indium tin oxide (ITO), indium zinc oxide (IZO), aluminum zinc oxide (AZO), and combinations thereof.

20. The method of claim 16, wherein the metal boride is selected from the group consisting of titanium boride (TiB2), zirconium boride (ZrB2), chromium boride (CrB2), and combinations thereof.

21. The method of claim 16, wherein the deposition comprises one selected from the group consisting of sputtering, thermal evaporation, electron beam evaporation, plasma enhanced vapor deposition (PECVD), physical vapor deposition (PVD), chemical vapor deposition (CVD), and combinations thereof.

22. The method of claim 16, wherein the metal substrate is selected from the group consisting of aluminum, titanium, niobium, chromium, tin, molybdenum, zinc, zirconium, vanadium, hafnium, tantalum, tungsten, indium, stainless steel, alloys thereof, and combinations thereof.

23. A method for making a separator for a fuel cell comprising:
mixing a metal powder and an electro-conductive anti-corrosion material selected from the group consisting of metal carbides, metal oxides, metal borides, and combinations thereof in an organic solvent, including a binder dissolved therein, to prepare a slurry; and
pouring the slurry into a mold and drying it to form a separator.

24. A fuel cell stack comprising:
a membrane-electrode assembly comprising a polymer electrolyte membrane and electrodes positioned at each side of the polymer electrolyte membrane; and
separators of claim 1 positioned at each side of the membrane-electrode assembly.
